(19) United States
(12) Patent Application Publication
(10) Pub. No.: US 2026/0230549 A1
(43) Pub. Date: Aug. 6, 2026

(54) MOBILE DEVICE HAVING CAMERA

(71) Applicant: Samsung Electronics Co., Ltd., Suwon-si (KR)

(72) Inventors: Stanislav PRYKHODKO, Kyiv (UA); Oleksandr BODNAR, Kyiv (UA); Andriy FISUNENKO, Kyiv (UA); Oleksandr SHCHUR, Kyiv (UA); Olena CHORNA, Kyiv (UA); Yevhen ROMANIAK, Kyiv (UA); Mykhailo ZLOTNYK, Kyiv (UA)

(21) Appl. No.: 19/631,280

(22) Filed: Mar. 27, 2026

Related U.S. Application Data
(63) Continuation of application No. PCT/KR2024/019399, filed on Nov. 29, 2024.

(30) Foreign Application Priority Data
Dec. 20, 2023 (KR) 10-2023-0187323

(51) Int. Cl. H04M 1/02; G01S 13/10; H01Q 1/24

(52) U.S. Cl. CPC H04M 1/0264; G01S 13/10; H01Q 1/245; H04M 1/0262

(57) ABSTRACT

A mobile device is provided. The mobile device includes a housing, a camera module on one surface of the housing, an internal antenna inside the housing, an external antenna, adjacent to the internal antenna, on an outside of the housing and spaced a certain distance from the one surface of the housing, and an antenna adjuster on the outside of the housing and configured to selectively electromagnetically couple the external antenna with the internal antenna, wherein, when the internal antenna is not electromagnetically coupled with the external antenna, electromagnetic waves radiated from the internal antenna forms a first antenna radiation pattern and wherein, when the internal antenna is electromagnetically coupled with the external antenna, the electromagnetic waves radiated from the internal antenna forms a second antenna radiation pattern.

### CROSS-REFERENCE TO RELATED APPLICATION(S)

This application is a continuation application, claiming priority under 35 U.S.C. § 365(c), of an International application No. PCT/KR2024/019399, filed on November 29, 2024, which is based on and claims the benefit of a Korean patent application number 10-2023-0187323, filed on December 20, 2023, in the Korean Intellectual Property Office, the disclosure of which is incorporated by reference herein in its entirety.

### BACKGROUND

### 1. Field

The disclosure relates to a mobile device. More particularly, the disclosure relates to a mobile device having a camera.

### 2. Description of Related Art

Generally, mobile devices utilize wireless technology for communication and sensing of their surroundings.

For example, mobile devices may utilize various wireless communication technologies, such as Bluetooth, wireless-fidelity (Wi-Fi), and ultra-wideband (UWB) communication. To achieve this, the mobile device may include an antenna compatible with the wireless communication technology used.

Furthermore, the mobile device may be configured to locate nearby devices equipped with tags using the antenna.

The mobile device may include a camera. The mobile device including the camera may measure the distance to a subject, focus, and perform real-time image processing.

Currently, mobile devices use optical distance sensors to measure the distance to a subject. The optical distance sensors are configured to utilize infrared or lasers to measure the distance to the subject.

UWB communication embedded in mobile devices is being used for the internet of things (IoT).

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a mobile device having a camera.

Additional aspects will be set forth in part in the description which follows and, in part, will be apparent from the description, or may be learned by practice of the presented embodiments.

In accordance with an aspect of the disclosure, a mobile device is provided. The mobile device includes a housing, a camera module on one surface of the housing, an internal antenna inside the housing, an external antenna, adjacent to the internal antenna, on an outside of the housing and spaced a certain distance from the one surface of the housing, and an antenna adjuster on the outside of the housing and configured to selectively electromagnetically couple the external antenna with the internal antenna, wherein, when the internal antenna is not electromagnetically coupled with the external antenna, electromagnetic waves radiated from the internal antenna form a first antenna radiation pattern, and wherein, when the internal antenna is electromagnetically coupled with the external antenna, the electromagnetic waves radiated from the internal antenna form a second antenna radiation pattern.

In accordance with another aspect of the disclosure, a camera module is provided. The camera module is configured to operate in a first operating mode and a second operating mode. When the internal antenna is not electromagnetically coupled with the external antenna, the camera module operates in the first operating mode. When the internal antenna is electromagnetically coupled with the external antenna, the camera module operates in the second operating mode.

According to an embodiment of the disclosure, the mobile device further includes a case configured to accommodate the housing. The external antenna and the antenna adjuster is disposed in the case.

According to an embodiment of the disclosure, the external antenna is configured as a passive antenna.

According to an embodiment of the disclosure, the antenna adjuster is configured to space the external antenna by a certain distance from the one surface of the housing and position the external antenna in one of a first position and a second position. The first position is a position where the external antenna is not electromagnetically coupled with the internal antenna, and the second position is a position where the external antenna is electromagnetically coupled with the internal antenna.

According to an embodiment of the disclosure, the mobile device further includes an antenna position detection part disposed in the housing and configured to detect the position of the external antenna. The camera module is configured to recognize the position of the external antenna using a signal transmitted from the antenna position detection part.

According to an embodiment of the disclosure, the antenna position detection part includes a magnetometer disposed in the housing, and the magnetometer is configured to detect a permanent magnet disposed in the external antenna.

According to an embodiment of the disclosure, the external antenna is configured as an active antenna. The mobile device includes a fixing part that spaces the external antenna from the one surface of the housing by a certain distance and fixes the external antenna to the one surface of the housing.

According to an embodiment of the disclosure, the antenna adjuster includes a power supply electrically connected to the external antenna, and a power switch between the external antenna and the power supply and configured to allow the power supply to selectively supply power to the external antenna. When the power switch is turned on and power is supplied from the power supply to the external antenna, the external antenna is electromagnetically coupled with the internal antenna so that the electromagnetic waves radiated from the internal antenna form the second antenna radiation pattern. When the power switch is turned off and power is not supplied to the external antenna, the external antenna is not electromagnetically coupled with the internal antenna so that the electromagnetic waves radiated from the internal antenna form the first antenna radiation pattern.

According to an embodiment of the disclosure, the external antenna includes four transmission lines arranged in a rectangular shape, and a plurality of switches disposed between the four transmission lines and configured to selectively divide the four transmission lines into two or four parts.

According to an embodiment of the disclosure, the mobile device further includes a distance measurement part configured to measure a distance to a subject captured by the camera module using electromagnetic waves radiated from the internal antenna.

According to an embodiment of the disclosure, the external antenna and the antenna adjuster are detachably disposed on a rear surface of the housing.

According to an embodiment of the disclosure, a distance G between the housing and the external antenna is 1/10 to 1/4 of a wavelength of the electromagnetic wave radiated from the internal antenna.

According to an embodiment of the disclosure, the internal antenna is configured to transmit or receive ultra-wideband (UWB) electromagnetic waves.

According to an embodiment of the disclosure, the internal antenna includes a transmitting antenna and a receiving antenna. The external antenna is disposed adjacent to one of the transmitting antenna and the receiving antenna.

In accordance with another aspect of the disclosure, a method of measuring a distance to a subject by a mobile device having an internal antenna, an external antenna, and a camera is provided. The method includes identifying whether the external antenna is activated, radiating electromagnetic waves through the internal antenna when the external antenna is activated, receiving the electromagnetic waves reflected from the subject, and calculating the distance to the subject.

According to an embodiment of the disclosure, when the external antenna is activated, the internal antenna is electromagnetically coupled with the external antenna, thereby changing a first antenna radiation pattern to a second antenna radiation pattern.

According to an embodiment of the disclosure, the mobile device includes an antenna adjuster configured to activate the external antenna.

In accordance with another aspect of the disclosure, one or more non-transitory computer-readable storage media storing one or more computer programs including computer-executable instructions that, when executed by one or more processors of mobile device having an internal antenna, an external antenna, and a camera individually or collectively, cause the mobile device to perform operations are provided. The operations include identifying whether the external antenna is activated, radiating electromagnetic waves through the internal antenna when the external antenna is activated, receiving the electromagnetic waves reflected from a subject, and calculating a distance to the subject.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating a mobile device according to an embodiment of the disclosure;

FIG. 2 is a block diagram illustrating a mobile device according to an embodiment of the disclosure;

FIG. 3 is a view illustrating a mobile device including a case according to an embodiment of the disclosure;

FIG. 4 is a cross-sectional view illustrating the mobile device of FIG. 3 taken along line A-A according to an embodiment of the disclosure;

FIG. 5 is a perspective view illustrating a case of a mobile device according to an embodiment of the disclosure;

FIG. 6 is a rear perspective view illustrating the case of the mobile device of FIG. 5 according to an embodiment of the disclosure;

FIG. 7 is a view illustrating a mobile device including a case according to an embodiment of the disclosure;

FIG. 8 is a diagram illustrating a first antenna radiation pattern and a second antenna radiation pattern of a mobile device according to an embodiment of the disclosure;

FIG. 9 is a diagram illustrating an external antenna and an antenna adjuster of a mobile device according to an embodiment of the disclosure;

FIG. 10 is a diagram illustrating an external antenna and an antenna adjuster of a mobile device according to an embodiment of the disclosure;

FIG. 11 is a view illustrating an external antenna and an antenna adjuster of a mobile device according to an embodiment of the disclosure;

FIG. 12 is a view illustrating a state in which the external antenna of the mobile device of FIG. 11 is positioned at a second position according to an embodiments of the disclosure;

FIG. 13 is a view illustrating a mobile device including a case according to an embodiment of the disclosure;

FIG. 14 is a cross-sectional view illustrating the mobile device of FIG. 13 taken along line B-B according to an embodiment of the disclosure;

FIG. 15 is a view illustrating a mobile device including a case according to an embodiment of the disclosure;

FIG. 16 is a cross-sectional view illustrating the mobile device of FIG. 15 taken along line C-C according to an embodiment of the disclosure;

FIG. 17 is a perspective view illustrating a mobile device including a case according to an embodiment of the disclosure;

FIG. 18A is a view illustrating a mobile device according to an embodiment of the disclosure;

FIG. 18B is a plan view illustrating the mobile device of FIG. 18A according to an embodiment of the disclosure;

FIG. 19 is a view illustrating a mobile device according to an embodiment of the disclosure;

FIG. 20 is a flowchart illustrating a method of capturing an image of a subject using a mobile device according to an embodiment of the disclosure;

FIG. 21 is a view illustrating a mobile device according to an embodiment of the disclosure; and

FIG. 22 is a view illustrating a mobile device and an external antenna according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In this disclosure, expressions such as “has,” “can have”, “includes,” or “can include” indicate the existence of a corresponding feature (e.g., numerical value, function, operation, or component such as a part) and do not preclude the existence of additional features.

In this disclosure, expressions such as “A or B,” “at least one of A or/and B,” or “one or more of A or/and B” may include all possible combinations of the items listed together. For example, “A or B,” “at least one of A or/and B,” or “one or more of A or/and B” may refer to all cases (1) including at least one A, (2) including at least one B, or (3) including both at least one A and at least one B.

Expressions such as “first,” “second,” “primary,” or “secondary,” as used in this disclosure may modify various components regardless of order and/or importance, are used only to distinguish one component from other components, and do not limit the corresponding components.

Further, terms such as ‘leading end’, ‘rear end’, ‘upper side’, ‘lower side’, ‘top end’, ‘bottom end’, etc. used in the disclosure are defined with reference to the drawings. However, the shape and position of each component are not limited by these terms.

An aspect of the disclosure is to provide a mobile device having a camera capable of measuring a distance to a subject using an internal antenna and an external antenna.

Hereinafter, a mobile device 1 according to various embodiments of the disclosure will be described in detail with reference to the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

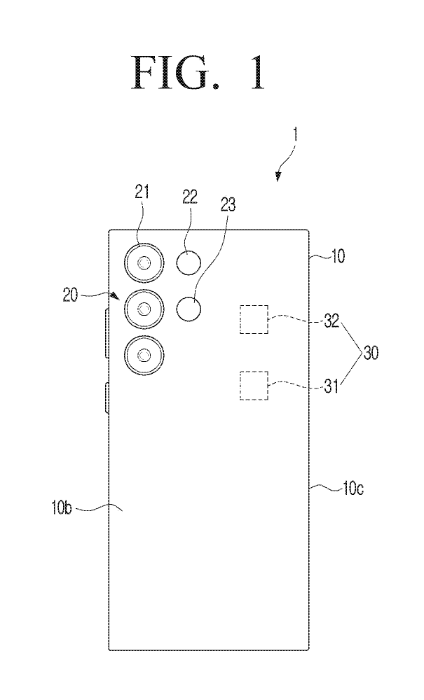

FIG. 1 is a view illustrating a mobile device according to an embodiment of the disclosure.

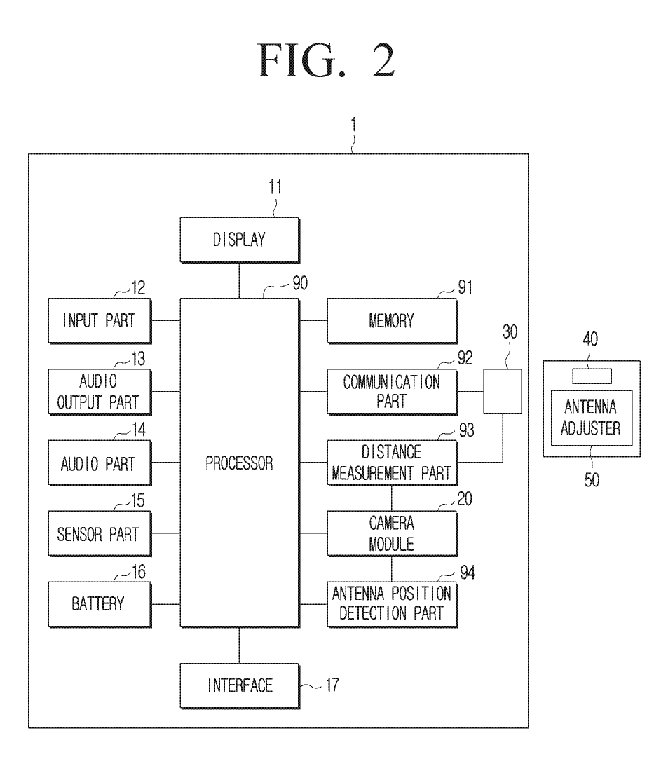

FIG. 2 is a block diagram illustrating a mobile device according to an embodiment of the disclosure.

Referring to FIGS. 1 and 2, a mobile device 1 according to various embodiments of the disclosure may include a housing 10, a camera module 20, an internal antenna 30, an external antenna 40, and an antenna adjuster 50.

The housing 10 may be formed in an approximately rectangular parallelepiped shape. The housing 10 may include a first surface 10a, a second surface 10b facing the first surface 10a, and four side surfaces 10c surrounding a space between the first surface 10a and the second surface 10b. A display 11 may be disposed on the first surface 10a. The first surface 10a on which the display is disposed may be referred to as the front surface of the housing 10. The camera module 20 may be disposed on the second surface 10b. The second surface 10b on which the camera module 20 is disposed may be referred to as the rear surface of the housing 10.

The camera module 20 may be configured to capture sill and moving images. The camera module 20 may be disposed on one surface of the housing 10. For example, the camera module 20 may be disposed on the second surface 10b of the housing 10. The camera module 20 may include a plurality of cameras 21. The plurality of cameras 21 may be disposed on the second surface 10b of the housing 10. The plurality of cameras 21 may have different fields of view (FoV). For example, the plurality of cameras 21 may include a standard camera, a wide-angle camera, and a telephoto camera.

In this embodiment, the camera module 20 may include three cameras 21. However, the number of cameras 21 is not limited thereto. The camera module 20 may include one, two, four, or more cameras 21.

The camera module 20 may include an image sensor. The camera module 20 may include a plurality of image sensors corresponding to the plurality of cameras 21.

The camera module 20 may include a flash 22. The flash 22 may include a light-emitting diode or a xenon lamp.

The camera module 20 may include an optical distance sensor 23. The optical distance sensor 23 may be configured to measure the distance to a subject. The optical distance sensor 23 may be configured to emit infrared or laser light to measure the distance to the subject and output a signal including the measured distance.

The camera module 20 may be configured to select one of the plurality of cameras 21 based on the distance to the subject. For example, the camera module 20 may be configured to receive the distance to the subject from the optical distance sensor 23, select one camera 21 most appropriate for capturing the subject at the received distance from among the plurality of cameras 21, and automatically adjust the focus to capture an image of the subject.

The camera module 20 may be configured to operate in a first operating mode and a second operating mode. The first operating mode refers to a mode in which the camera module 20 captures a subject at a close range. The second operating mode refers to a mode in which the camera module 20 captures a subject at a long range.

The internal antenna 30 may be disposed inside the housing 10. The internal antenna 30 may be disposed adjacent to or in contact with the inner surface of the second surface 10b of the housing 10 in which the cameras 21 are disposed. The internal antenna 30 may be disposed adjacent to the camera module 20 on the second surface 10b of the housing 10. The internal antenna 30 may be configured to emit or receive ultra-wideband (UWB) electromagnetic waves.

The internal antenna 30 may include a transmitting antenna 31 and a receiving antenna 32. The transmitting antenna 31 may be configured to radiate electromagnetic waves. The receiving antenna 32 may be configured to receive electromagnetic waves. For example, the internal antenna 30 may include the transmitting antenna 31 that radiates ultra-wideband electromagnetic waves and the receiving antenna 32 that receives ultra-wideband electromagnetic waves. As another example, the internal antenna 30 may be configured as a transmitting and receiving antenna that can transmit and receive ultra-wideband electromagnetic waves.

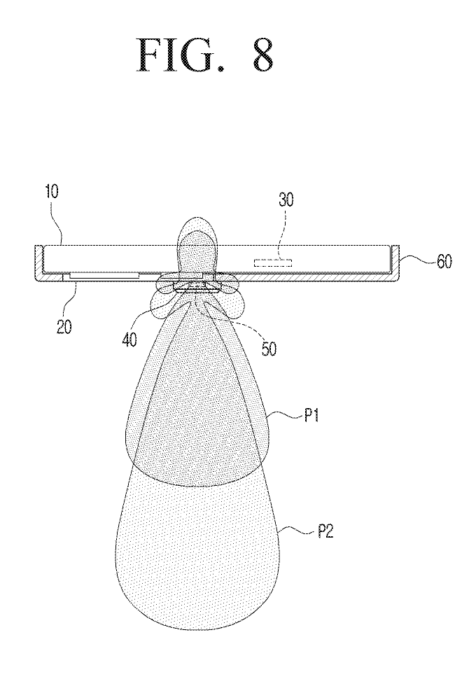

The electromagnetic waves radiated from the internal antenna 30 may form a certain radiation pattern. The radiation pattern formed by the electromagnetic waves radiated from the internal antenna 30 is referred to as a first antenna radiation pattern or a first antenna diagram (see FIG. 8).

The mobile device 1 may include a display 11, an input part 12, an audio output part 13, an audio part 14, a sensor part 15, a battery 16, an interface 17, a communication part 92, a distance measurement part 93, a processor 90, and memory 91.

The display 11 may be configured to display text and images. Still images or moving images captured by the camera module 20 may be output through the display 11. The display 11 may include a touch sensor and a pressure sensor.

The input part 12 may be configured to receive commands or data for controlling the mobile device 1 from a user. For example, the input part 12 may include a microphone, a mouse, a keyboard, keys or buttons, a stylus pen, etc.

The audio output part 13 may be configured to output audio signals to the outside of the mobile device 1. For example, the audio output part 13 may include a speaker or a receiver. The speaker may be used for general purpose, such as multimedia playback or recording playback. The receiver may be used to receive incoming calls. The receiver may be implemented separately from the speaker or as part of the speaker.

The audio part 14 may be configured to convert sound into an electrical signal, or vice versa. For example, the audio part 14 may acquire sound through the input part 12 or output sound through the audio output part 13.

The sensor part 15 may be configured to detect the operating status of the mobile device 1 or the external environment and generate an electrical signal or data value corresponding to the detected status. For example, the sensor part 15 may include a gyro sensor, a pressure sensor, a magnetic sensor, an acceleration sensor, a grip sensor, a proximity sensor, a color sensor, an infrared sensor, a biometric sensor, a temperature sensor, a humidity sensor, an illuminance sensor, etc.

The interface 17 may be configured to connect the mobile device 1 to an external electronic device, either wired or wirelessly. For example, the interface 17 may include a high definition multimedia interface (HDMI), a universal serial bus (USB), an SD card, an audio interface, etc.

The battery 16 may be configured to supply power to at least one component of the mobile device 1. For example, the battery 16 may include a non-rechargeable primary battery, a rechargeable secondary battery, etc.

The communication part 92 may be configured to enable the mobile device 1 to communicate with an external electronic device, either wired or wirelessly. For example, the communication part 92 may be connected to an external electronic device via various communication methods, such as Bluetooth, Wi-Fi, fourth generation (4G), fifth generation (5G), and the like.

The communication part 92 may transmit data to or receive data from the external electronic device via the internal antenna 30. When the internal antenna 30 is configured as an ultra-wideband antenna capable of transmitting or receiving ultra-wideband electromagnetic waves, the communication part 92 may transmit and receive a large amount of data.

The distance measurement part 93 may be configured to measure the distance to a subject captured by the camera module 20 using electromagnetic waves radiated from the internal antenna 30. The electromagnetic waves emitted from the internal antenna 30 may be reflected by the subject and become reflected waves. The distance measurement part 93 may be configured to receive the reflected waves reflected from the subject and calculate the distance to the subject.

As another example, the distance measurement part 93 may be configured as part of the processor 90. In this case, the processor 90 may calculate the distance to the subject by using electromagnetic waves emitted from the internal antenna 30 and reflected from the subject.

The processor 90 may control at least one component of the mobile device 1, such as hardware or software components. The processor 90 may be configured to perform various data processing or calculations.

The memory 91 may store programs, such as an operating system and applications, which control the mobile device 1, and various data used by at least one component of the mobile device 1. The memory 91 may include volatile memory or non-volatile memory.

The mobile device 1 may include an antenna position detection part 94. The antenna position detection part 94 may be configured to detect the position of the external antenna 40. For example, the antenna position detection part 94 may be configured to detect whether the external antenna 40 is located in a first position or a second position.

Referring to FIG. 2, the external antenna 40 and the antenna adjuster 50 may be disposed on the outside of the mobile device 1.

The external antenna 40 may be configured to change the radiation pattern of the electromagnetic wave radiated from the internal antenna 30, i.e., the first antenna radiation pattern or first antenna diagram of the internal antenna 30. The radiation pattern of the electromagnetic wave radiated from the internal antenna 30 changed by the external antenna 40 is referred to as a second antenna radiation pattern or second antenna diagram.

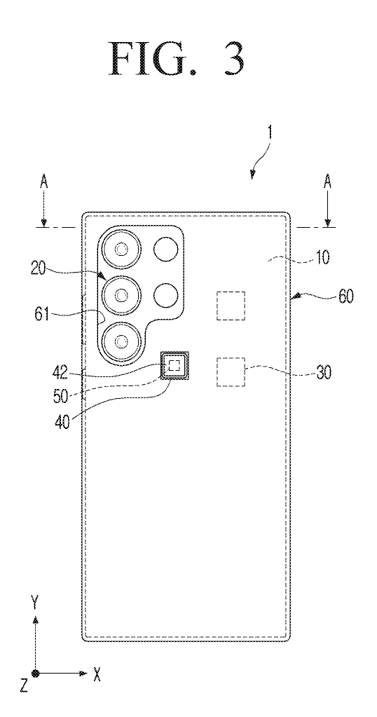

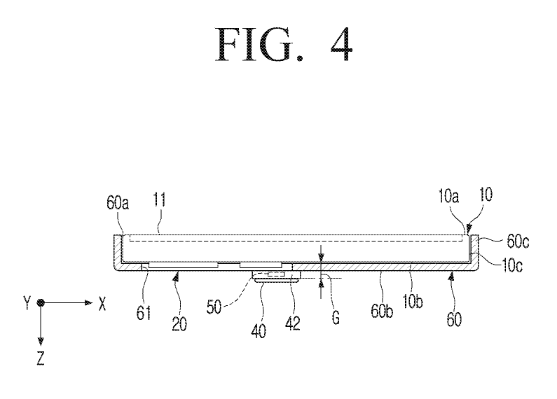

The external antenna 40 may be disposed horizontally adjacent to the internal antenna 30 on the outside of the housing 10 (X-Y plane in FIG. 3). The external antenna 40 may be disposed horizontally adjacent to the camera module 20 on the outside of the housing 10. The external antenna 40 may be disposed on the outside of the housing 10 so as to be spaced apart from the internal antenna 30 by a certain distance in the vertical direction (Z direction in FIGS. 3 and 4). For example, the external antenna 40 may be disposed so that the gap G between the rear surface 10b of the housing 10 and the external antenna 40 is 1/10 to 1/4 of the wavelength of the electromagnetic wave radiated from the internal antenna 30.

The gap G between the rear surface 10b of the housing 10 and the external antenna 40 refers to the distance between the rear surface 10b of the housing 10 and one end or surface of the external antenna 40 located closest to the rear surface 10b when the external antenna 40 is electromagnetically coupled with the internal antenna 30. For example, in FIG. 4, the gap G between the rear surface 10b of the housing 10 and the external antenna 40 refers to the distance between the rear surface 10b of the housing 10 and one surface of the external antenna 40 attached to a fixing part 42.

For example, the external antenna 40 may be disposed on the rear surface 60b of a case 60 in which the housing 10 is accommodated.

The antenna adjuster 50 may be disposed on the outside of the housing 10. For example, the antenna adjuster 50 may be disposed on the case 60. The antenna adjuster 50 may be disposed on the rear surface 60b of the case 60 together with the external antenna 40.

The antenna adjuster 50 may be configured to selectively electromagnetically couple the external antenna 40 with the internal antenna 30. When the internal antenna 30 is electromagnetically coupled with the external antenna 40, the antenna radiation pattern of the internal antenna 30 may be changed.

For example, when the internal antenna 30 is not electromagnetically coupled to the external antenna 40 by the antenna adjuster 50, the internal antenna 30 may form a first antenna radiation pattern. However, when the internal antenna 30 is electromagnetically coupled to the external antenna 40 by the antenna adjuster 50, the internal antenna 30 may form a second antenna radiation pattern. The second antenna radiation pattern may be different from the first antenna radiation pattern. For example, the width of the major lobe of the second antenna radiation pattern may be narrower than the width of the major lobe of the first antenna radiation pattern.

In other words, when the internal antenna 30 is electromagnetically coupled to the external antenna 40, the level of electromagnetic waves emitted from the internal antenna 30 may increase compared to when the external antenna 40 is not electromagnetically coupled to the internal antenna 30. Therefore, when the internal antenna 30 and the external antenna 40 are electromagnetically coupled to each other, the direct wave (Line of Sight (LoS)) may increase and the indirect wave (Non-Line of Sight (NLoS)) may decrease.

The antenna adjuster 50 may be configured electrically or mechanically. This will be described later.

FIG. 3 is a view illustrating a mobile device 1 including a case according to an embodiment of the disclosure.

FIG. 4 is a cross-sectional view illustrating the mobile device 1 of FIG. 3 taken along line A-A according to an embodiment of the disclosure.

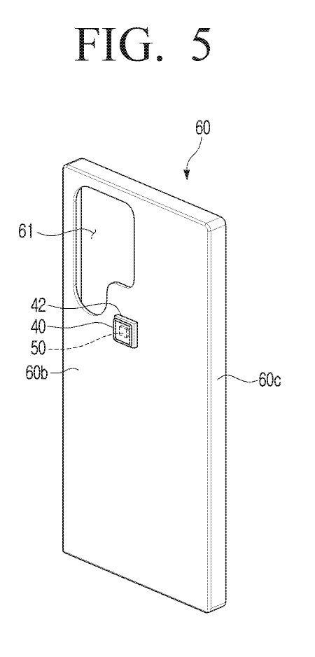

FIG. 5 is a perspective view illustrating a case of a mobile device 1 according to an embodiment of the disclosure.

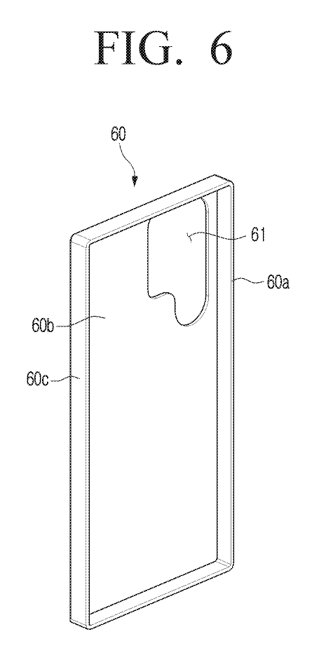

FIG. 6 is a rear perspective view illustrating the case 60 of the mobile device 1 of FIG. 5 according to an embodiment of the disclosure.

Referring to FIGS. 3 and 4, a mobile device 1 according to various embodiments of the disclosure may include a case 60.

The mobile device 1 may include the camera module 20 disposed on the rear surface 10b of the housing 10. The camera module 20 may include three cameras 21. The camera module 20 may include an optical distance sensor 23 and a flash 22. The optical distance sensor 23 and the flash 22 may be disposed adjacent to the three cameras 21 on the rear surface 10b of the housing 10.

The mobile device 1 may include the internal antenna 30. The internal antenna 30 may be disposed inside the housing 10. The internal antenna 30 may be disposed adjacent to or in contact with the inner surface of the rear surface 10b of the housing 10. The internal antenna 30 may be disposed adjacent to the camera module 20.

The internal antenna 30 may include a transmitting antenna 31 and a receiving antenna 32. The internal antenna 30 may include the transmitting antenna 31 configured to transmit ultra-wideband electromagnetic waves and the receiving antenna 32 configured to receive ultra-wideband electromagnetic waves.

The mobile device 1 may be accommodated in the case 60. In other words, the housing 10 of the mobile device 1 may be accommodated in the case 60.

The case 60 may be formed in a shape corresponding to the housing 10 of the mobile device 1. For example, when the housing 10 is formed in a roughly rectangular flat plate shape, the case 60 may be formed to accommodate the housing 10 having the rectangular flat plate shape. In other words, the case 60 may be formed to surround the rear surface 10b and side surfaces 10c of the housing 10. The front 60a of the case 60 may be opened to expose the display 11 of the mobile device 1. For example, the case 60 may be formed in a roughly rectangular box shape having a height corresponding to the thickness of the housing 10.

The case 60 may include the external antenna 40 and the antenna adjuster 50. The external antenna 40 and the antenna adjuster 50 may be provided on the rear surface 60b of the case 60.

Referring to FIGS. 3 to 6, the case 60 may be formed in a box shape having a substantially rectangular cross-section. In other words, the case 60 may include the rear surface 60b and four side surfaces 60c. The four side surfaces 60c may extend vertically from the rear surface 60b. The front 60a of the case 60 may be formed with an opening communicating with the internal space of the case 60. The mobile device 1 may be accommodated in the internal space of the case 60 through the opening in the front 60a of the case 60.

When the mobile device 1 is accommodated in the case 60, the rear surface 10b and four side surfaces 10c of the housing 10 may be in contact with the rear surface 60b and four side surfaces 60c of the case 60. The display 11 of the mobile device 1 may be exposed through the opening in the front 60a of the case 60.

The case 60 may include a camera hole 61 through which the camera module 20 is exposed. The camera hole 61 may be formed on the rear surface 60b of the case 60. Through the camera hole 61, the plurality of cameras 21, the optical distance sensor 23, and the flash 22 of the camera module 20 may be exposed.

The external antenna 40 may be disposed on the rear surface 60b of the case 60. The external antenna 40 may be disposed so as to be spaced apart from the rear surface 10b of the housing 10 of the mobile device 1 by a certain distance in the vertical direction (Z direction). In other words, a certain gap G may exist between the external antenna 40 and the rear surface 10b of the housing 10. Therefore, the external antenna 40 may be spaced apart from the internal antenna 30 disposed on the inside of the rear surface 10b of the housing 10 by the certain gap G in the vertical direction.

The gap G between the rear surface 10b of the housing 10 and the external antenna 40 refers to a distance between the rear surface 10b of the housing 10 and one end or one surface of the external antenna 40 that is positioned closest to the rear surface 10b of housing 10 when the external antenna 40 is electromagnetically coupled to the internal antenna 30. In FIG. 4, the certain gap G refers to the distance between the rear surface 10b of the housing 10 and one surface of the external antenna 40 attached to the fixing part 42.

When the certain gap G exists between the external antenna 40 and the rear surface 10b of the housing 10, the external antenna 40 may be electromagnetically coupled with the internal antenna 30 to change the antenna radiation pattern of the internal antenna 30. Hereinafter, the gap G between the rear surface 10b of the housing 10 and the external antenna 40, at which the external antenna 40 may be electromagnetically coupled with the internal antenna 30 to change the antenna radiation pattern of the internal antenna 30, is referred to as an antenna installation gap G.

For example, the antenna installation gap G between the rear surface 10b of the housing 10 and the external antenna 40 may be 1/10 to 1/4 of the wavelength of the electromagnetic wave radiated from the internal antenna 30.

To this end, a gap maintaining part may be provided between the rear surface 60b of the case 60 and the external antenna 40. The gap maintaining part may be formed so that the gap between the rear surface 10b of the housing 10 and the external antenna 40 maintain the antenna installation gap G.

For example, the gap maintaining part may be formed as a fixing part 42 that secures the external antenna 40 to the case 60. A hook-and-loop fastener or Velcro may be used as the fixing part 42. When the thickness of the fixing part 42 is appropriately defined, the external antenna 40 may be disposed on the rear surface 60b of the case 60 using the fixing part 42, thereby maintaining the antenna installation gap G between the rear surface 10b of the housing 10 and the external antenna 40.

As another example, the rear surface 60b of the case 60 may be formed as the gap maintaining part. The case 60 may formed such that when the external antenna 40 is disposed to contact the rear surface 60b of the case 60, the thickness of the rear surface 60b of the case 60 corresponds to the antenna installation gap G. When the external antenna 40 is disposed inside the rear surface 60b of the case 60, the case 60 may be formed so that the thickness of the case 60 up to the external antenna 40 built into the case 60 corresponds to the antenna installation gap G.

Various types of antennas may be used as the external antenna 40. The external antenna 40 may be configured as a directional antenna. The mobile device 1 according to this embodiment may use a quad antenna as the external antenna 40. The quad antenna may be fixed to the rear surface 60b of the case 60 by the fixing part 42.

The external antenna 40 may be disposed on the rear surface 60b of the case 60 so that when the mobile device 1 is accommodated in the case 60, the external antenna 40 is adjacent to the internal antenna 30 of the mobile device 1 in the horizontal direction (X-Y plane). For example, the external antenna 40 may be disposed on the rear surface 60b of the case 60 so that when the mobile device 1 is accommodated in the case 60, the external antenna 40 is positioned between the camera module 20 and the internal antenna 30.

When the external antenna 40 may be disposed on the rear surface 60b of the case 60 so as to be adjacent to the transmitting antenna 31 of the internal antenna 30 of the mobile device 1. Then, when the mobile device 1 is accommodated in the case 60, the external antenna 40 may be adjacent to the transmitting antenna 31 of the mobile device 1. In this case, the external antenna 40 may be disposed approximately in the center of the case 60.

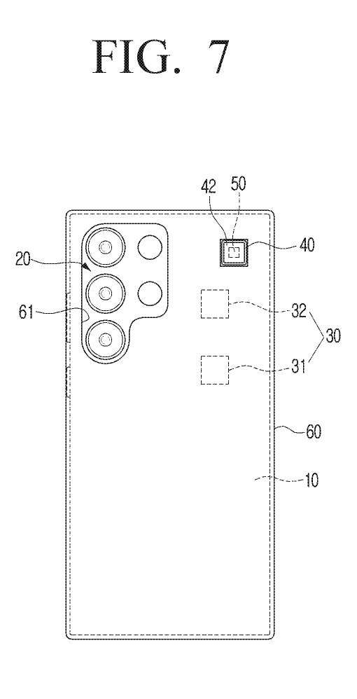

As another example, the external antenna 40 may be disposed on the rear surface 60b of the case 60 so as to be adjacent to the receiving antenna 32 of the internal antenna 30 of the mobile device 1. In other words, the external antenna 40 may be disposed in the case 60 as illustrated in FIG. 7.

FIG. 7 is a view illustrating a mobile device including a case according to an embodiment of the disclosure.

Referring to FIG. 7, the external antenna 40 may be disposed adjacent to the upper end of the rear surface 60b of the case 60. At this time, the receiving antenna 32 of the internal antenna 30 of the mobile device 1 may be disposed on the upper portion of the rear surface 10b of the housing 10. Therefore, the external antenna 40 may be positioned between the upper end of the rear surface 60b of the case 60 and the receiving antenna 32 of the internal antenna 30.

However, the installation position of the external antenna 40 is not limited thereto. The installation position of the external antenna 40 may vary depending on the location of the internal antenna 30 disposed inside the housing 10 of the mobile device 1.

The antenna adjuster 50 may be disposed on the rear surface 60b of the case 60. For example, the antenna adjuster 50 may be disposed within the fixing part 42. Alternatively, the antenna adjuster 50 may be disposed on the rear surface 60b of the case 60 or inside the rear surface 60b.

The antenna adjuster 50 may be configured to selectively electromagnetically couple the external antenna 40 with the internal antenna 30. In other words, the antenna adjuster 50 may either electromagnetically couple the external antenna 40 with the internal antenna 30 or prevent the external antenna 40 from electromagnetically coupling with the internal antenna 30. The antenna adjuster 50 may be configured to electrically or mechanically adjust the coupling between the external antenna 40 and the internal antenna 30.

When the internal antenna 30 is not electromagnetically coupled with the external antenna 40 by the antenna adjuster 50, the electromagnetic waves radiated from the internal antenna 30 may form the first antenna radiation pattern. When the internal antenna 30 is electromagnetically coupled with the external antenna 40 by the antenna adjuster 50, the electromagnetic waves radiated from the internal antenna 30 may form the second antenna radiation pattern.

Therefore, when the internal antenna 30 is not electromagnetically coupled with the external antenna 40, the camera module 20 may operate in the first operating mode. When the internal antenna 30 is electromagnetically coupled with the external antenna 40, the camera module 20 may operate in the second operating mode.

Hereinafter, with reference to FIG. 8, the antenna radiation pattern of the mobile device 1 according to an embodiment of the disclosure will be described in detail.

FIG. 8 is a diagram illustrating a first antenna radiation pattern and a second antenna radiation pattern of a mobile device according to an embodiment of the disclosure.

Referring to FIG. 8, the first antenna radiation pattern P1 represents a case where the internal antenna 30 is operational and the external antenna 40 is not electromagnetically coupled with the internal antenna 30. In other words, the first antenna radiation pattern P1 represents a case where electromagnetic waves are radiated only from the internal antenna 30. The first antenna radiation pattern P1 may be defined according to the structure and shape of the internal antenna 30.

The main lobe of the of the first antenna radiation pattern P1 may be wide at its maximum width and short at its length. Therefore, the internal antenna 30 may be used to locate an external electronic device equipped with a tag in the vicinity and communicate with the external electronic device. In addition, the first antenna radiation pattern P1 may be used to measure the distance to a nearby subject.

The second antenna radiation pattern P2 represents a case where the internal antenna 30 and the external antenna 40 are electromagnetically coupled with each other and the internal antenna 30 radiates electromagnetic waves. In other words, the second antenna radiation pattern P2 represents a case where electromagnetic waves are radiated from the coupled internal antenna 30 and external antenna 40.

The main lobe of the second antenna radiation pattern P2 may be similar in the maximum width to that of the first antenna radiation pattern P1, but may be longer than the main lobe of the first antenna radiation pattern P1. Accordingly, the second antenna radiation pattern P2 may radiate electromagnetic waves to a longer distance than the first antenna radiation pattern P1 or receive electromagnetic waves radiated from a longer distance than the first antenna radiation pattern P1. Therefore, the second antenna radiation pattern P2 may be used to measure the distance to the subject located at a long distance.

For example, when the internal antenna 30 and the external antenna 40 are electromagnetically coupled to each other, the internal antenna 30 disposed inside the housing 10 may operate as a driven element and a reflector, and the external antenna 40 may operate as a director. In other words, the electromagnetic coupling of the internal antenna 30 and the external antenna 40 may mean that the external antenna 40 operates as a director to change the first antenna radiation pattern P1 of the internal antenna 30 into the second antenna radiation pattern P2.

Therefore, when the external antenna 40 is used, as in the mobile device 1 according to various embodiments of the disclosure, the antenna radiation pattern of the internal antenna 30 may be changed. In other words, by electromagnetically coupling the internal antenna 30 with the external antenna 40, the first antenna radiation pattern P1 of the internal antenna 30 may be changed to the second antenna radiation pattern P2 without changing the mechanical structure of the internal antenna 30.

The antenna adjuster 50 may be disposed in the case 60 and may be configured to selectively electromagnetically couple the external antenna 40 with the internal antenna 30. In other words, the antenna adjuster 50 may adjust the external antenna 40 so that the external antenna 40 is electromagnetically coupled or not coupled with the internal antenna 30. Accordingly, the electromagnetic waves emitted from the internal antenna 30 may be formed into one of the first antenna radiation pattern P1 and the second antenna radiation pattern P2 by the antenna adjuster 50.

The antenna adjuster 50 may be configured to electrically or mechanically adjust the coupling the external antenna 40 and the internal antenna 30.

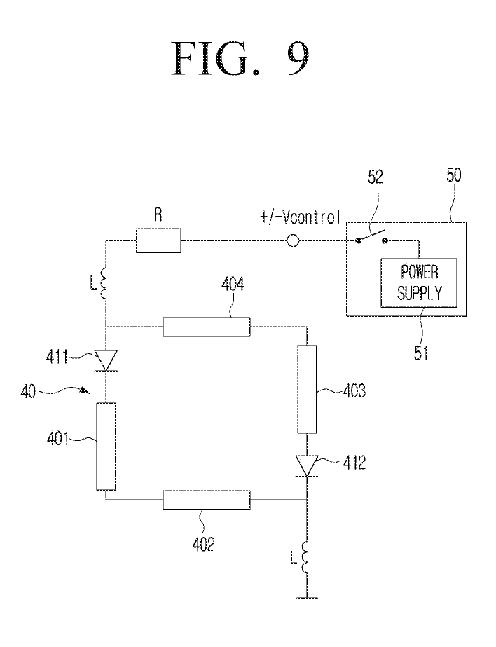

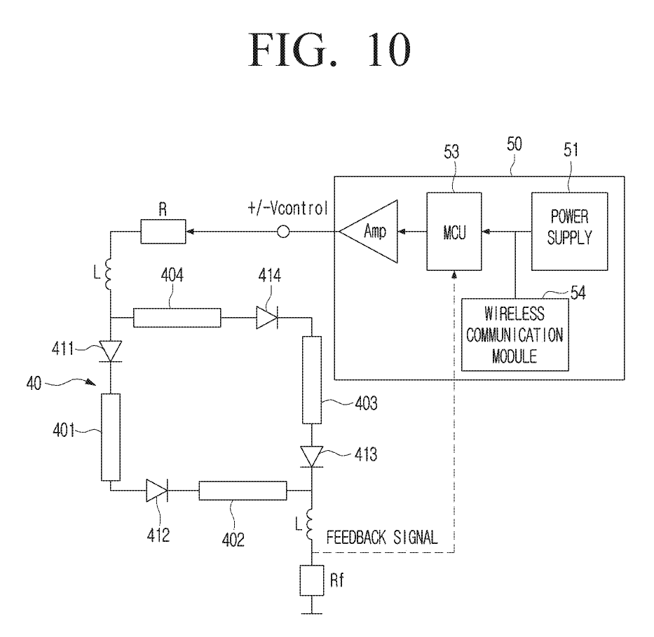

First, the electrically configured antenna adjuster 50 will be described in detail with reference to FIGS. 9 and 10.

FIG. 9 is a diagram illustrating an external antenna and an antenna adjuster of a mobile device according to an embodiment of the disclosure.

Referring to FIG. 9, the antenna adjuster 50 may include a power supply 51 electrically connected to the external antenna 40 and a power switch 52 disposed between the external antenna 40 and the power supply 51.

The power switch 52 may be configured to allow the power supply 51 to selectively supply power to the external antenna 40. In other words, when the power switch 52 is turned on, power from the power supply 51 may be supplied to the external antenna 40, allowing the external antenna 40 to function as an antenna. When the power supply 51 is turned off, power from the power supply 51 may not be supplied to the external antenna 40, preventing the external antenna 40 from function as an antenna.

The power switch 52 may be configured to be manually turned on and off by a user. Alternatively, the power switch 52 may be configured to be wirelessly controlled. In this case, the user may turn the power switch 52 on/off via the mobile device 1.

The external antenna 40 may be disposed at a location where it is able to be electromagnetically coupled with the internal antenna 30 of the mobile device 1. For example, the external antenna 40 may be disposed horizontally adjacent to the internal antenna 30.

The external antenna 40 may include four transmission lines 401, 402, 403, and 404 arranged in a rectangular shape and a plurality of switches disposed between the four transmission lines 401, 402, 403, and 404. The plurality of switches may be arranged so as to divide the four transmission lines 401, 402, 403, and 404 into two or four parts. The four transmission lines 401, 402, 403, and 404 and the plurality of switches may be disposed on a printed circuit board.

The lengths of the four transmission lines 401, 402, 403, and 404 may each be formed as 1/4λ. Here, λ is the wavelength of the electromagnetic wave emitted from the internal antenna 30.

The four transmission lines 401, 402, 403, and 404 may be arranged in a rectangular shape. In other words, the four transmission lines 401, 402, 403, and 404 may form four sides of the rectangle. Two switches 411 and 412 may be disposed between the four transmission lines 401, 402, 403, and 404 to divide the four transmission lines 401, 402, 403, and 404 into two parts. For example, a first switch 411 may be disposed between a first transmission line 401 and a fourth transmission line 404, and a second switch 412 may be disposed between a second transmission line 402 and a third transmission line 403.

When the power switch 52 is turned on and power is supplied to the external antenna 40 from the power supply 51, two switches 411 and 412 may be turned on so that the four transmission lines 401, 402, 403, and 404 are electrically connected. Then, the four transmission lines 401, 402, 403, and 404 may operate as the external antenna 40. Therefore, when the power switch 52 is turned on, the external antenna 40 may be electromagnetically coupled with the internal antenna 30, so that the first antenna radiation pattern P1 of the internal antenna 30 is changed to the second antenna radiation pattern P2. In other words, the electromagnetic waves radiated from the internal antenna 30 may form the second antenna radiation pattern P2.

When the power switch 52 is turned off and power is not supplied to the external antenna 40 from the power supply 51, the two switches 411 and 412 may be turned off so that the four transmission lines 401, 402, 403, and 404 are electrically divided into two parts. In other words, the first transmission line 401 and the second transmission line 40 connected by wires may form a first part, and the third transmission line 403 and the fourth transmission line 404 connected by wires may form a second part. The first part and the second part may be disconnected from each other by the two switches 411 and 412. Therefore, when the power switch 52 is turned off and power is not supplied, the four transmission lines 401, 402, 403, and 404 do not function as the external antenna 40. Accordingly, when the power switch 52 is turned off, the external antenna 40 may not be electromagnetically coupled with the internal antenna 30, so the first antenna radiation pattern P1 of the internal antenna 30 may not change. In other words, the electromagnetic waves radiated from the internal antenna 30 may form the first antenna radiation pattern P1.

In the embodiment illustrated in FIG. 9, p-i-n diodes are used as the switches 411 and 412. However, the switches used in the disclosure are not limited thereto. For example, the switches may be radio frequency (RF) switches, field effect transistors (FETs), radio frequency (RF) modules, etc.

The power supply 51 may be configured to supply power to the external antenna 40. The power supply 51 may be configured in various ways as long as it can supply power to the external antenna 40. For example, the power supply 51 may be configured as a battery. Alternatively, the power supply 51 may be configured to receive power wirelessly from an external power supply. For example, the power supply 51 may be configured to receive power wirelessly from the mobile device 1 and supply power to the external antenna 40.

In FIG. 9, +/-Vcontrol represents a voltage regulator that regulates the voltage supplied to the external antenna 40. In addition, R and L represents a resistor and an inductor, respectively.

FIG. 10 is a diagram illustrating an external antenna and an antenna adjuster of a mobile device according to an embodiment of the disclosure.

The external antenna 40 may be disposed at a location where the external antenna 40 is able to be electromagnetically coupled with the internal antenna 30 of the mobile device 1.

Referring to FIG. 10, the external antenna 40 may include four transmission lines 401, 402, 403, and 404 arranged in a rectangular shape and four switches 411, 412, 413, and 414 disposed between the four transmission lines 401, 402, 403, and 404. The four switches 411, 412, 413, and 414 may be arranged so as to divide the four transmission lines 401, 402, 403, and 404 into four parts. The four transmission lines 401, 402, 403, and 404 and the four switches 411, 412, 413, and 414 may be disposed on a printed circuit board.

The lengths of the four transmission lines 401, 402, 403, and 404 may each be formed as 1/4λ. Here, λ is the wavelength of the electromagnetic wave emitted from the internal antenna 30.

The four transmission lines 401, 402, 403, and 404 may be arranged in a rectangular shape. In other words, the four transmission lines 401, 402, 403, and 404 may form four sides of the rectangle. The four switches 411, 412, 413, and 414 may be disposed between the four transmission lines 401, 402, 403, and 404 to divide the four transmission lines 401, 402, 403, and 404 into four parts. In other words, a first switch 411 may be disposed between a first transmission line 401 and a fourth transmission line 404, and a second switch 412 may be disposed between the first transmission line 401 and a second transmission line 402. The third switch 413 may be disposed between the second transmission line 402 and a third transmission line 403, and a fourth switch 414 may be disposed between the third transmission line 403 and the fourth transmission line 404.

When power is supplied to the external antenna 40 from the power supply 51, four switches 411, 412, 413, and 414 may be turned on so that the four transmission lines 401, 402, 403, and 404 are electrically connected. Then, the four transmission lines 401, 402, 403, and 404 may operate as the external antenna 40. Therefore, when power is supplied to the external antenna 40, the external antenna 40 may be electromagnetically coupled with the internal antenna 30, so that the first antenna radiation pattern P1 of the internal antenna 30 is changed to the second antenna radiation pattern P2. In other words, the electromagnetic waves radiated from the internal antenna 30 may form the second antenna radiation pattern P2.

When power is not supplied to the external antenna 40 from the power supply 51, the four switches 411, 412, 413, and 414 may be turned off, so that the four transmission lines 401, 402, 403, and 404 are electrically divided into four parts. In other words, the first transmission line 401 and the fourth transmission line 404 may be disconnected from each other by the first switch 411, and the first transmission line 401 and the second transmission line 402 may be disconnected from each other by the second switch 412. The second transmission line 402 and the third transmission line 403 may be disconnected from each other by the third switch 413, and the third transmission line 403 and the fourth transmission line 404 may be disconnected from each other by the fourth switch 414. Accordingly, the first transmission line 401, the second transmission line 402, the third transmission line 403, and the fourth transmission line 404 may form four divided parts.

When power is not supplied to the external antenna 40 from the power supply 51, the four transmission lines 401, 402, 403, and 404 may be disconnected from each other and therefore may not function as the external antenna 40. Accordingly, when power is not supplied to the external antenna 40, the external antenna 40 may not be electromagnetically coupled with the internal antenna 30, and thus the first antenna radiation pattern P1 of the internal antenna 30 may not change. In other words, the electromagnetic waves radiated from the internal antenna 30 may form the first antenna radiation pattern P1.

In the embodiment illustrated in FIG. 10, p-i-n diodes are used as the switches 411, 412, 413, and 414. However, the switches used in the disclosure are not limited thereto. For example, the switches may be radio frequency switches, field effect transistors, radio frequency modules, etc.

The antenna adjuster 50 may be configured to wirelessly turn the external antenna 40 on and off. When the external antenna 40 is turned on by the antenna adjuster 50, the external antenna 40 may function as an antenna. When the external antenna 40 is turned off, the external antenna 40 may not function as an antenna.

For example, the antenna adjuster 50 may include a power supply 51, a micro controller unit (MCU) 53, and a wireless communication module 54.

The power supply 51 may be configured to supply power to the external antenna 40. The power supply 51 may be configured in various ways as long as it can supply power to the external antenna 40. For example, the power supply 51 may be configured as a battery. Alternatively, the power supply 51 may be configured to receive power wirelessly from the mobile device 1.

The MCU 53 may be configured to control the power supply 51. The MCU 53 may control the power supply 51 to selectively supply power to the external antenna 40. In addition, the MCU 53 may be configured to receive a feedback signal from the external antenna 40. The MCU 53 may recognize whether the external antenna 40 is on or off through the feedback signal.

The wireless communication module 54 may be configured to wirelessly receive an on/off command for the external antenna 40 and transmit it to the MCU 53. For example, the wireless communication module 54 may be configured to wirelessly receive an on/off command for the external antenna 40 from the mobile device 1.

The mobile device 1 may include an antenna app capable of controlling the antenna adjuster 50. The user may transmit an on/off command for the external antenna 40 to the wireless communication module 54 via the antenna app. The antenna app may be configured to transmit an external antenna on/off command to the wireless communication module 54 of the antenna adjuster 50 via the communication part 92.

Upon receiving the external antenna on command from the wireless communication module 54, the MCU 53 may control the power supply 51 to supply power to the external antenna 40. When power from the power supply 51 is supplied to the external antenna 40, the external antenna 40 may function as an antenna.

Upon receiving the external antenna off command from the wireless communication module 54, the MCU 53 may control the power supply 51 to block power from being supplied to the external antenna 40. When power from the power supply 51 is not supplied to the external antenna 40, the external antenna 40 may not function as an antenna.

In addition, in FIG. 10, +/-Vcontrol represents a voltage regulator that regulates the voltage supplied to the external antenna 40, and R and L represents a resistor and an inductor, respectively.

The external antenna 40 illustrated in FIGS. 9 and 10 may function as an antenna that is electromagnetically coupled to the internal antenna 30 when power is supplied. However, when power is not supplied, it may not function as an antenna that is electromagnetically coupled to the internal antenna 30. This external antenna 40 may be referred to as an active antenna.

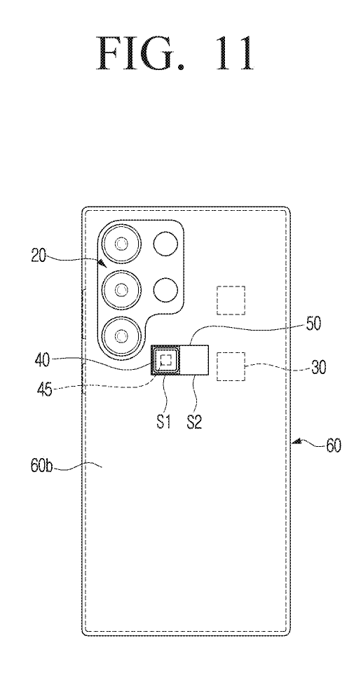

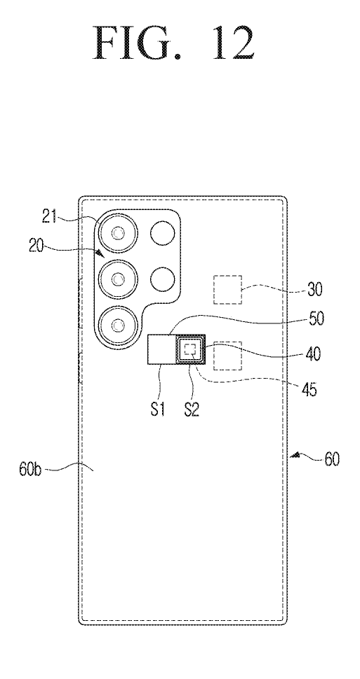

Next, a mechanically configured antenna adjuster 50 will be described in detail with reference to FIGS. 11 and 12.

FIG. 11 is a view illustrating an external antenna and an antenna adjuster of a mobile device according to an embodiment of the disclosure.

FIG. 12 is a view illustrating a state in which the external antenna of the mobile device of FIG. 11 is positioned at a second position according to an embodiment of the disclosure.

Referring to FIG. 11, an external antenna 40 may be disposed on the rear surface 60b of the case 60 using an antenna adjuster 50.

The antenna adjuster 50 may be configured as an antenna shifter capable of positioning the external antenna 40 at either a first position S1 or a second position S2. In other words, the shape of the external antenna 40 may be maintained, and the position of the external antenna 40 may be changed by the antenna adjuster 50, i.e., the antenna shifter. In addition, the external antenna 40 may be spaced a certain distance from the rear surface 10b of the housing 10 by the antenna shifter. Therefore, by appropriately defining the thickness of the antenna shifter, the external antenna 40 may maintain the antenna installation gap G from the rear surface 10b of the housing 10.

The first position S1 may be a position where the external antenna 40 is not electromagnetically coupled with the internal antenna 30. For example, the first position S1 may be a position where the external antenna 40 is located at a greater distance from the internal antenna 30 than the second position S2. When the external antenna 40 is located at the first position S1 by the antenna adjuster 50, the external antenna 40 may not be electromagnetically coupled with the internal antenna 30. Therefore, when the external antenna 40 is located at the first position S1, the electromagnetic waves emitted from the internal antenna 30 may form the first antenna radiation pattern P1. In other words, the external antenna 40 located at the first position S1 may not affect the first antenna radiation pattern P1 of the internal antenna 30.

The second position S2 may be a position where the external antenna 40 is electromagnetically coupled with the internal antenna 30. For example, the second position S2 may be a position where the external antenna 40 is located closer to the internal antenna 30 than the first position S1. When the external antenna 40 is located at the second position S2 by the antenna adjuster 50, the external antenna 40 may be electromagnetically coupled with the internal antenna 30. Therefore, when the external antenna 40 is located at the second position S2, the electromagnetic waves emitted from the internal antenna 30 may form the second antenna radiation pattern P2. In other words, the external antenna 40 located at the second position S2 may affect the internal antenna 30 to change the first antenna radiation pattern P1 of the internal antenna 30 into the second antenna radiation pattern P2.

The antenna adjuster 50 may be configured in various ways, as long as it can position the external antenna 40 in one of two positions. For example, the antenna adjuster 50 may be configured as a mechanical slider structure capable of shifting the external antenna 40 by a certain distance. In detail, the external antenna 40 may be disposed on a moving plate, and the moving plate may be configured to slide relative to a base disposed on the rear surface 60b of the case 60.

The antenna adjuster 50 may be configured to manually move the external antenna 40. Alternatively, the antenna adjuster 50 may be configured to automatically move the external antenna 40. For example, the antenna adjuster 50 may be configured to move the moving plate on which the external antenna 40 is disposed using a motor, solenoid, air pressure, or the like.

The mobile device 1 may be configured to recognize the position of the external antenna 40. In other words, the mobile device 1 may be configured to recognize whether the external antenna 40 is located at the first position S1 or the second position S2. To this end, the mobile device 1 may include an antenna position detection part 94 (see FIG. 2).

The antenna position detection part 94 may be disposed in the housing 10 and configured to detect the position of the external antenna 40. The processor 90 and the camera module 20 may recognize the position of the external antenna 40 through the antenna position detection part 94.

For example, the antenna position detection part 94 may be configured as a magnetometer. The magnetometer (i.e., antenna position detection part 94) may be disposed in the housing 10 of the mobile device 1. The magnetometer (i.e., antenna position detection part 94) may be configured to detect a permanent magnet 45. The permanent magnet 45 may be disposed in the external antenna 40. When the external antenna 40 is disposed on the moving plate, the permanent magnet 45 may be disposed on the moving plate. Therefore, the permanent magnet 45 may move integrally with the external antenna 40.

The magnetometer (i.e., antenna position detection part 94) may be configured to output a signal upon detecting the permanent magnet 45. For example, the magnetometer (i.e., antenna position detection part 94) may be configured to not output a signal when the external antenna 40 is at the first position S1, and to output a signal when the external antenna 40 is at the second position S2.

The camera module 20 may be configured to recognize the position of the external antenna 40 using a signal transmitted from the antenna position detection part 94. When the external antenna 40 is at the second position S2, the camera module 20 may measure the distance to the subject using the internal antenna 30 and the external antenna 40. The camera module 20 may directly measure the distance to the subject using the internal antenna 30 and the external antenna 40 through the distance measurement part 93, and may select an appropriate camera among the plurality of cameras 21 according to the distance to the subject to capture the subject.

When the processor 90 is configured to control the camera module 20, the processor 90 may recognize the position of the external antenna 40 using a signal output from the antenna position detection part 94. When the external antenna 40 is at the second position S2, the processor 90 may measure the distance to the subject using the internal antenna 30 and the external antenna 40. The processor 90 may measure the distance to the subject using the internal antenna 30 and the external antenna 40 through the distance measurement part 93, and may control the camera module 20 based on the distance to the subject to select an appropriate camera among the plurality of cameras 21 and capture the subject.

When the external antenna 40 is at the first position S1, the processor 90 may locate an external electronic device equipped with a tag using the internal antenna 30. For example, the processor 90 may use ultra-wideband communication to locate an external electronic device and communicate with the external electronic device.

The external antenna 40 illustrated in FIGS. 11 and 12 may function as an antenna that is electromagnetically coupled to the internal antenna 30 regardless of power supply. Such an antenna may be referred to as a passive antenna.

The above illustrates and describes a case that the external antenna 40 is configured as a quad antenna. However, the external antenna 40 according to various embodiments of the disclosure is not limited thereto. Antennas having various shapes may be used as the external antenna 40, as long as they are directional antennas.

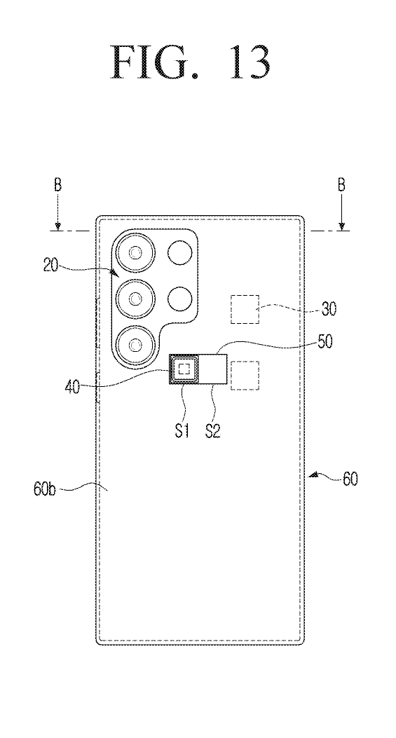

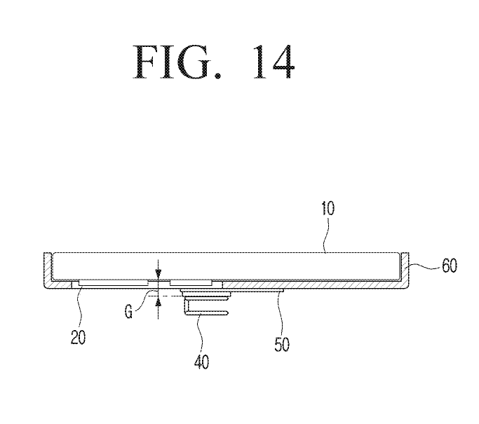

A case where a double quad antenna is used as the external antenna 40 will be described with reference to FIGS. 13 and 14.

FIG. 13 is a view illustrating a mobile device including a case according to an embodiment of the disclosure.

FIG. 14 is a cross-sectional view illustrating the mobile device 1 of FIG. 13 taken along line B-B according to an embodiment of the disclosure.

Referring to FIGS. 13 and 14, a mobile device 1 according to various embodiments of the disclosure may include a case 60.

Because the mobile device 1 is the same as or similar to the aforementioned embodiment, a detailed description thereof is omitted.

The mobile device 1 may be accommodated in the case 60. The case 60 may be formed in a shape corresponding to the housing 10 of the mobile device 1. Because the case 60 is the same as or similar to the aforementioned embodiment, a detailed description thereof is omitted.

The case 60 may include an external antenna 40 and an antenna adjuster 50. The external antenna 40 and the antenna adjuster 50 may be provided on the rear surface 60b of the case 60. In this embodiment, the antenna adjuster 50 is the same as that of the aforementioned embodiment, and the structure of the external antenna 40 is different therefrom.

The external antenna 40 may be disposed on the rear surface 60b of the case 60. The external antenna 40 may be disposed so as to be spaced apart from the rear surface 10b of the housing 10 of the mobile device 1 by a certain distance in the vertical direction. The external antenna 40 may maintain a certain gap G from the rear surface 10b of the housing 10 by means of the antenna adjuster 50. In other words, the antenna adjuster 50 may function as a gap maintaining part.

The gap G between the rear surface 10b of the housing 10 and the external antenna 40 refers to a distance between the rear surface 10b of the housing 10 and one end or one surface of the external antenna 40 that is positioned closest to the rear surface 10b of the housing 10 when the external antenna 40 is electromagnetically coupled to the internal antenna 30. In FIG. 14, the gap G between the rear surface 10b of the housing 10 and the external antenna 40 refers to the distance between the rear surface 10b of the housing 10 and one surface of the external antenna 40 attached to the antenna adjuster 50.

The external antenna 40 may be configured as a dual quad antenna. The dual quad antenna 40 may be a form in which the two quad antennas of the above-described embodiment are arranged in parallel.

When the dual quad antenna 40 is positioned at the first position S1 by the antenna adjuster 50, the dual quad antenna 40 may not be electromagnetically coupled with the internal antenna 30. Therefore, when the dual quad antenna 40 is positioned at the first position S1, the electromagnetic waves emitted from the internal antenna 30 may form the first antenna radiation pattern P1.

When the dual quad antenna 40 is positioned at the second position S2 by the antenna adjuster 50, the dual quad antenna 40 may be electromagnetically coupled with the internal antenna 30. Therefore, when the dual quad antenna 40 is positioned at the second position S2, the electromagnetic waves emitted from the internal antenna 30 may form the second antenna radiation pattern P2.

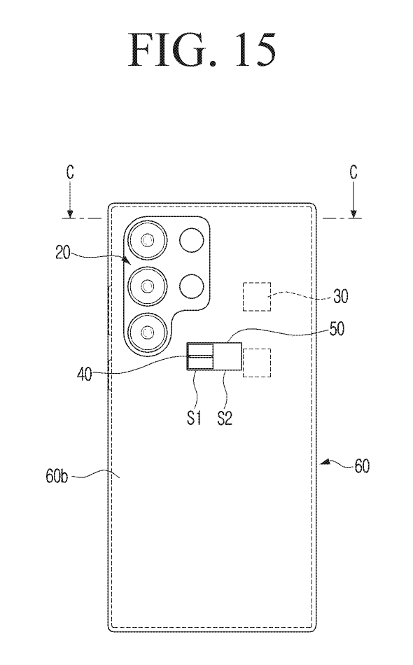

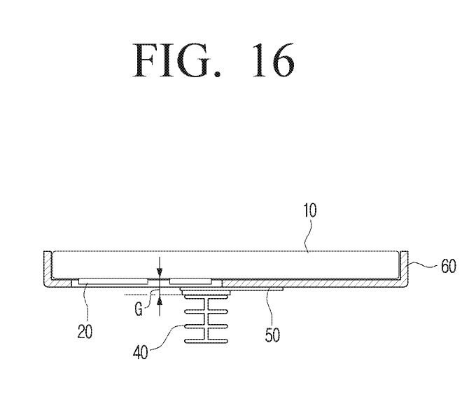

The case where a Yagi antenna is used as the external antenna 40 will be described with reference to FIGS. 15 and 16.

FIG. 15 is a view illustrating a mobile device including a case according to an embodiment of the disclosure.

FIG. 16 is a cross-sectional view illustrating the mobile device of FIG. 15 taken along line C-C according to an embodiment of the disclosure.

Referring to FIGS. 15 and 16, a mobile device 1 according to various embodiments of the disclosure may include a case 60.

Because the mobile device 1 is the same as or similar to the aforementioned embodiment, a detailed description thereof is omitted.

The mobile device 1 may be accommodated in the case 60. The case 60 may be formed in a shape corresponding to the housing 10 of the mobile device 1. Because the case 60 is the same as or similar to the aforementioned embodiment, a detailed description thereof is omitted.

The case 60 may include an external antenna 40 and an antenna adjuster 50. The external antenna 40 and the antenna adjuster 50 may be provided on the rear surface 60b of the case 60.

The antenna adjuster 50 may be configured to position the external antenna 40 in one of the first position S1 and the second position S2. In this embodiment, the antenna adjuster 50 is the same as that of the aforementioned embodiment, and the structure of the external antenna 40 is different therefrom.

The external antenna 40 may be disposed on the rear surface 60b of the case 60. The external antenna 40 may be disposed to be spaced apart from the rear surface 10b of the housing 10 of the mobile device 1 by a certain distance. The external antenna 40 may maintain a certain gap G from the rear surface 10b of the housing 10 by means of the antenna adjuster 50. In other words, the antenna adjuster 50 may function as a gap maintaining part.

The gap G between the rear surface 10b of the housing 10 and the external antenna 40 refers to a distance between the rear surface 10b of the housing 10 and one end or one surface of the external antenna 40 that is positioned closest to the rear surface 10b of the housing 10 when the external antenna 40 is electromagnetically coupled to the internal antenna 30. In FIG. 16, the gap G between the rear surface 10b of the housing 10 and the external antenna 40 refers to the distance between the rear surface 10b of the housing 10 and one end of the external antenna 40 attached to the antenna adjuster 50.

The external antenna 40 may be configured as a Yagi antenna.

When the Yagi antenna 40 is positioned at the first position S1 by the antenna adjuster 50, the Yagi antenna 40 may not be electromagnetically coupled with the internal antenna 30. Therefore, when the Yagi antenna 40 is positioned at the first position S1, the electromagnetic waves emitted from the internal antenna 30 may form the first antenna radiation pattern P1.

When the Yagi antenna 40 is positioned at the second position S2 by the antenna adjuster 50, the Yagi antenna 40 may be electromagnetically coupled with the internal antenna 30. Therefore, when the Yagi antenna 40 is positioned at the second position S2, the electromagnetic waves emitted from the internal antenna 30 may form the second antenna radiation pattern P2.

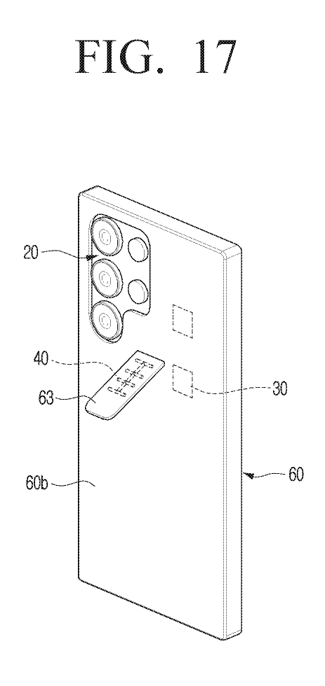

FIG. 17 is a perspective view illustrating a mobile device including a case according to an embodiment of the disclosure.

Referring to FIG. 17, the case 60 may include a holder 63. The holder 63 may be disposed on the rear surface 60b of the case 60. The holder 63 may be disposed adjacent to the internal antenna 30 of the mobile device 1 accommodated in the case 60.

The holder 63 may be configured to support the case 60. For example, the holder 63 may be formed so that holder 63 is able to rotate at a certain angle with respect to the rear surface 60b of the case 60 with one end as the center. Accordingly, when the holder 63 is folded, the rear surface of the holder 63 may contact the rear surface 60b of the case 60. In addition, the holder 63 may be located at a certain angle away from the rear surface 60b of the case 60. When the holder 63 is spaced apart from the rear surface 60b of the case 60 at a certain angle, the holder 63 may support the mobile device 1 accommodated in the case 60 at a certain angle with respect to the floor.

The external antenna 40 may be disposed inside the holder 63. When the holder 63 is positioned approximately perpendicular to the rear surface 60b of the case 60, the external antenna 40 may be electromagnetically coupled to the internal antenna 30. Accordingly, the first antenna radiation pattern P1 of the internal antenna 30 may be changed to the second antenna radiation pattern P2. When the holder 63 contacts the rear surface 60b of the case 60, the external antenna 40 may not be electromagnetically coupled to the internal antenna 30. Accordingly, the first antenna radiation pattern P1 of the internal antenna 30 may not change. In other words, the user may control the coupling between the internal antenna 30 and the external antenna 40 by adjusting the position of the holder 63. In other words, the holder 63 may function as the antenna adjuster 50.

As another example, the external antenna 40 may be disposed on the surface of the holder 63.

In the above, the case 60 is formed in a substantially rectangular box shape as an example, but the case 60 is not limited thereto. The case 60 may be formed in various shapes depending on the shape of the housing 10 of the mobile device 1.

For example, when the mobile device 1 is a foldable device that is able to be folded and unfolded, such as a foldable phone, the case 60 may be configured to accommodate the foldable device.

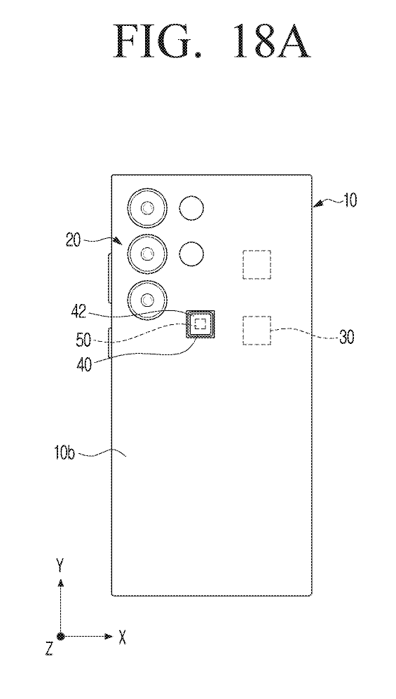

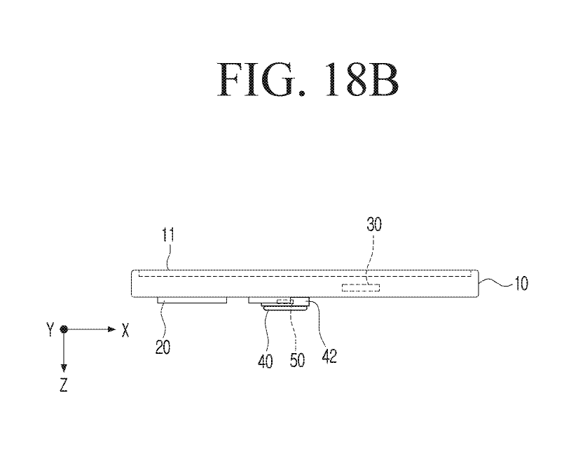

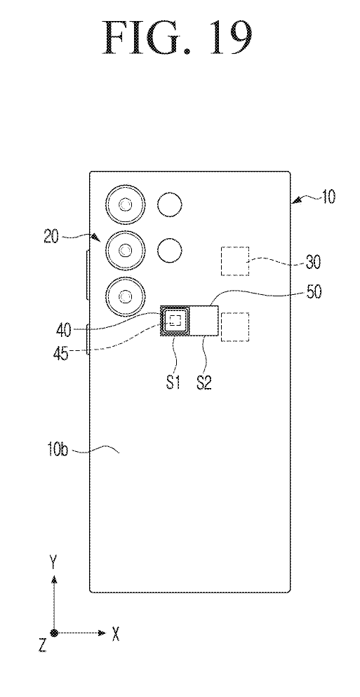

In the above, the case where the external antenna 40 and the antenna adjuster 50 are disposed in the case 60 has been described, but the mobile device 1 according to various embodiments of the disclosure is not limited thereto. As illustrated in FIGS. 18A, 18B, and 19, the external antenna 40 may be disposed on the rear surface 10b of the housing 10 of the mobile device 1.

FIG. 18A is a view illustrating a mobile device according to an embodiment of the disclosure.

FIG. 18B is a plan view illustrating the mobile device of FIG. 18A according to an embodiment of the disclosure.

Referring to FIGS. 18A and 18B, the mobile device 1 according to various embodiments of the disclosure may include an external antenna 40 and an antenna adjuster 50.

The external antenna 40 may be disposed on the rear surface 10b of the housing 10 of the mobile device 1. The external antenna 40 may be disposed in a location where the external antenna 40 is able to be electromagnetically coupled to the internal antenna 30. For example, the external antenna 40 may be disposed adjacent to the internal antenna 30 in the horizontal direction (X-Y plane).

The external antenna 40 may be disposed to be spaced a certain distance away from the rear surface 10b of the housing 10 in the vertical direction (Z direction). Accordingly, the external antenna 40 may be spaced a certain distance in the vertical direction from the internal antenna 30 disposed in the inside of the rear surface 10b of the housing 10. For example, the antenna installation gap G between the rear surface 10b of the housing 10 and the external antenna 40 may be 1/10 to 1/4 of the wavelength of the electromagnetic wave radiated from the internal antenna 30.

The external antenna 40 may be disposed on the rear surface 10b of the housing 10 using a fixing part 42. The thickness of the fixing part 42 may be defined as the antenna installation gap G. For example, a hook and loop fastener may be used as the fixing part 42.

The antenna adjuster 50 may be configured to electrically adjust the coupling between the external antenna 40 and the internal antenna 30. The antenna adjuster 50 may be disposed in the fixing part 42.

The external antenna 40 and the antenna adjuster 50 according to this embodiment may be configured in the same manner as the external antenna 40 and the antenna adjuster 50 described in FIGS. 9 and 10.

FIG. 19 is a view illustrating a mobile device according to an embodiment of the disclosure.

Referring to FIG. 19, the mobile device 1 according to an embodiment of the disclosure may include an external antenna 40 and an antenna adjuster 50.

The external antenna 40 may be disposed on the rear surface 10b of the housing 10 of the mobile device 1. The external antenna 40 may be disposed on the rear surface 10b of the housing 10 with the antenna adjuster 50.

The antenna adjuster 50 may be configured as an antenna shifter capable of positioning the external antenna 40 at either a first position S1 or a second position S2. Therefore, the external antenna 40 may be positioned at either the first position S1 or the second position S2 by the antenna adjuster 50, i.e., the antenna shifter. In addition, the external antenna 40 may be spaced a certain distance vertically (Z direction) from the rear surface 10b of the housing 10 by the antenna shifter. Therefore, when the thickness of the antenna shifter is appropriately defined, the external antenna 40 may be spaced apart from the rear surface 10b of the housing 10 by the antenna installation gap G.

The first position S1 may be a position where the external antenna 40 is not electromagnetically coupled with the internal antenna 30. When the external antenna 40 is positioned at the first position S1 by the antenna adjuster 50, the external antenna 40 may not be electromagnetically coupled with the internal antenna 30. Therefore, when the external antenna 40 is located at the first position S1, the electromagnetic waves emitted from the internal antenna 30 may form the first antenna radiation pattern P1.

The second position S2 may be a position where the external antenna 40 is electromagnetically coupled with the internal antenna 30. When the external antenna 40 is positioned at the second position S2 by the antenna adjuster 50, the external antenna 40 may be electromagnetically coupled with the internal antenna 30. Therefore, when the external antenna 40 is located at the second position S2, the electromagnetic waves emitted from the internal antenna 30 may form the second antenna radiation pattern P2.

The antenna adjuster 50 may be configured in various structures, as long as it can position the external antenna 40 at one of the two positions. For example, the antenna adjuster 50 may be configured as a mechanical slider structure capable of shifting the external antenna 40. In detail, the external antenna 40 may be disposed on a moving plate, and the moving plate may be configured to slide relative to a base disposed on the rear surface of the housing 10.

The mobile device 1 may be configured to recognize the position of the external antenna 40. In other words, the mobile device 1 may be configured to recognize whether the external antenna 40 is located at the first position S1 or the second position S2. To this end, the mobile device 1 may include an antenna position detection part 94.

The antenna position detection part 94 may be disposed in the housing 10 and configured to detect the position of the external antenna 40. The processor 90 and the camera module 20 may recognize the position of the external antenna 40 through the antenna position detection part 94.

For example, the antenna position detection part 94 may be configured as a magnetometer. The magnetometer (i.e., antenna position detection part 94) may be disposed in the housing 10 of the mobile device 1. The magnetometer (i.e., antenna position detection part 94) may be configured to detect a permanent magnet 45. The permanent magnet 45 may be disposed in the external antenna 40. When the external antenna 40 is disposed on the moving plate, the permanent magnet 45 may be disposed on the moving plate. Therefore, the permanent magnet 45 may move integrally with the external antenna 40.

The magnetometer (i.e., antenna position detection part 94) may be configured to output a signal upon detecting the permanent magnet 45. For example, the magnetometer (i.e., antenna position detection part 94) may be configured not to output a signal when the external antenna 40 is at the first position S1, and to output a signal when the external antenna 40 is at the second position S2.

The camera module 20 may be configured to recognize the position of the external antenna 40 using a signal transmitted from the antenna position detection part 94. When the processor 90 is configured to control the camera module 20, the processor 90 may recognize the position of the external antenna 40 using a signal output from the antenna position detection part 94.

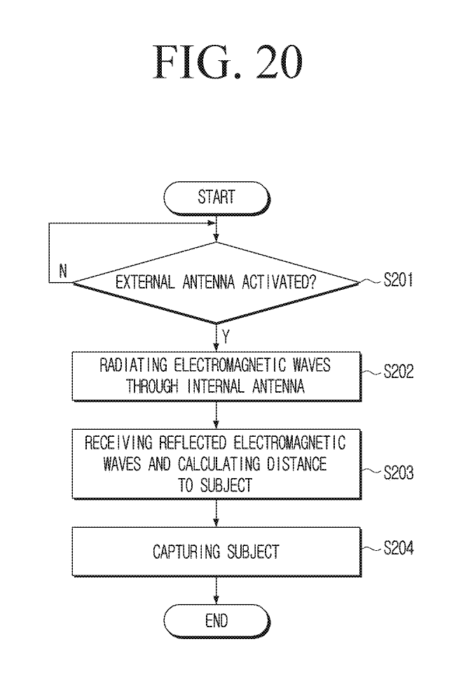

Hereinafter, a method of capturing an image of a subject using a mobile device 1 according to various embodiments of the disclosure having the above-described structure will be described with reference to FIG. 20.

FIG. 20 is a flowchart illustrating a method of capturing an image of a subject using a mobile device according to an embodiment of the disclosure.

Referring to FIG. 20, the processor 90 may identify whether the external antenna 40 is activated at operation S201.

The external antenna 40 may be activated by the antenna adjuster 50. For example, the user may activate the external antenna 40 using the antenna adjuster 50. Here, activating the external antenna 40 means that the external antenna 40 is in a state where the external antenna 40 is able to be electromagnetically coupled with the internal antenna 30.

For example, when the antenna adjuster 50 is electrically configured, this means that the user supplies power to the external antenna 40 using the antenna adjuster 50, enabling the external antenna 40 to function as an antenna. When the external antenna 40 is mechanically configured, this means that the user uses the antenna adjuster 50 to move the external antenna 40 to the second position S2.

When the external antenna 40 is activated, the processor 90 may radiate electromagnetic waves through the internal antenna 30 at operation S220. For example, the processor 90 may control the distance measurement part 93 to radiate electromagnetic waves through the internal antenna 30. At this time, because the internal antenna 30 is electromagnetically coupled to the external antenna 40, the electromagnetic waves radiated from the internal antenna 30 may form a second antenna radiation pattern P2.

When the external antenna 40 is not activated and the processor 90 radiates electromagnetic waves through the internal antenna 30, the electromagnetic waves radiated from the internal antenna 30 may form a first antenna radiation pattern P1.

Next, the processor 90 may receive the reflected electromagnetic waves and calculate the distance to the subject at operation S203. For example, the electromagnetic waves radiated through the internal antenna 30 and the external antenna 40 may be reflected by the subject and received by the coupled internal antenna 30 and external antenna 40. Then, the distance measurement part 93 may calculate the distance to the subject using the received electromagnetic waves (i.e., reflected waves). In other words, the distance measurement part 93 may measure the distance from the mobile device 1 to the subject using the electromagnetic waves radiated through the coupled internal antenna 30 and external antenna 40.

The processor 90 may control the camera module 20 in response to the distance to the subject to capture an image of the subject at operation S204. For example, the processor 90 may select one of the plurality of cameras 21 of the camera module 20 according to the measured distance to the subject and capture the subject. At this time, the camera module 20 may operate in the second operating mode to capture the subject at a long distance.

In the above, the case where the processor 90 controls the distance measurement part 93 to measure the distance to the subject and controls the camera module 20 to capture the subject has been described, but this disclosure is not limited thereto. As another example, the camera module 20 may control the distance measurement part 93 to measure the distance to the subject and capture an image of the subject.

By measuring the distance to the subject using an ultra-wideband antenna, such as the mobile device 1 according to various embodiments of the disclosure, the distance to the subject may be measured under extreme conditions where the optical distance sensor does not operate. For example, the distance to the subject may be measured in extremely bright locations or in locations with highly transparent or highly reflective surfaces, such as mirrors, windows, glass doors, and the like.

The above describes a smartphone as an example of the mobile device 1 according to various embodiments of the disclosure. However, the disclosure is not limited thereto. The disclosure may be applied to various mobile devices 1.

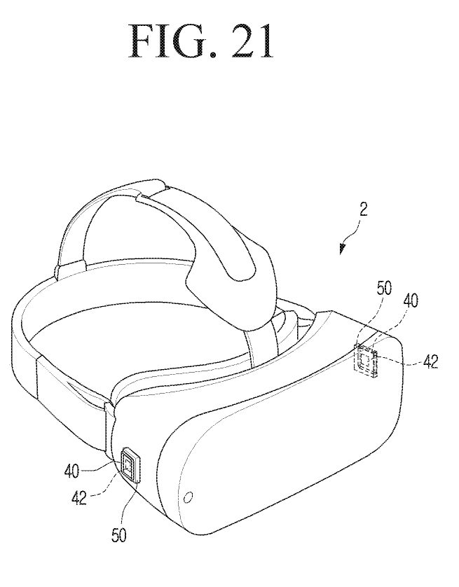

For example, as illustrated in FIG. 21, a mobile device according to an embodiment of the disclosure may be implemented as a head-mounted device (HMD) 2.

FIG. 21 a view illustrating a mobile device according to an embodiment of the disclosure.

Referring to FIG. 21, two external antennas 40 may be disposed on the left and right side surfaces of the head-mounted device 2. The external antennas 40 may be secured to the head-mounted device 2 by fixing parts 42. Using a hook-and-loop fastener as the fixing part 42 may allow the external antenna 40 to be detachably secured to the head-mounted device 2.

FIG. 21 illustrates a quad antenna as the external antenna 40. However, the type of the external antenna 40 is not limited thereto. Any type of directional antenna may be used as the external antenna 40.

The head-mounted device 2 may include antenna adjusters 50. The antenna adjusters 50 may be the same as or similar to those in the above-described embodiment, and thus, a detailed description thereof is omitted.

The head-mounted device 2 may include internal antennas 30. The internal antennas 30 may be provided on the left and right sides of the interior of the head-mounted device 2. The internal antennas 30 may be configured to transmit and receive ultra-wideband electromagnetic waves.

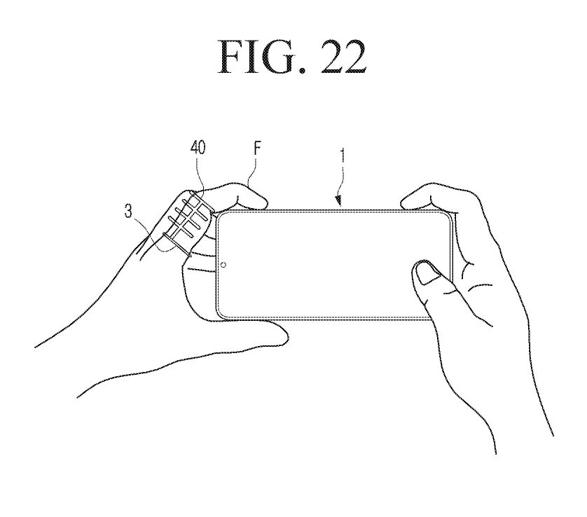

FIG. 22 is a view illustrating a mobile device and an external antenna according to an embodiment of the disclosure.

Referring to FIG. 22, the external antenna 40 may be disposed on the user’s finger F. For example, by attaching the external antenna 40 to a ring 3 and wearing the ring 3 on the finger F, the external antenna 40 may be secured to the user’s finger F. The user may change the direction of the main lobe of the antenna radiation pattern of the external antenna 40 by changing the direction of the finger F.

FIG. 22 illustrates a Yagi antenna as the external antenna 40. However, the type of the external antenna 40 is not limited thereto. Any type of directional antenna may be used as the external antenna 40.

The mobile device 1 may include an internal antenna. The internal antenna may be configured to transmit and receive ultra-wideband electromagnetic waves.

Referring to FIG. 22, when the user holds the mobile device 1 while wearing the ring 3 integrated with the external antenna 40 on the finger F and photographs a subject, the mobile device 1 may measure the distance to the subject using the external antenna 40.

In addition, the mobile device 1 according to various embodiments of the disclosure may increase the length of the main lobe of the radiation pattern of the ultra-wideband electromagnetic wave emitted from the internal antenna 30 by using the external antenna 40. Therefore, it may locate an external device equipped with a tag at a greater distance than when using only the internal antenna 30.

For example, when locating a car equipped with a tag using a smartphone, a smartphone including the external antenna 40 according to various embodiments of the disclosure may locate the car at a greater distance than smartphones according to the prior art without the external antenna 40.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A mobile device comprising: a housing; a camera on one surface of the housing; an internal antenna inside the housing; an external antenna, adjacent to the internal antenna, on an outside of the housing and spaced a certain distance from the one surface of the housing; and an antenna adjuster on an outside of the housing and configured to selectively electromagnetically couple the external antenna with the internal antenna, wherein, when the internal antenna is not electromagnetically coupled with the external antenna, electromagnetic waves radiated from the internal antenna form a first antenna radiation pattern, and wherein, when the internal antenna is electromagnetically coupled with the external antenna, the electromagnetic waves radiated from the internal antenna form a second antenna radiation pattern.

2. The mobile device of claim 1, wherein the camera is configured to operate in a first operating mode and a second operating mode, and wherein when the internal antenna is not electromagnetically coupled with the external antenna, the camera operates in the first operating mode, and when the internal antenna is electromagnetically coupled with the external antenna, the camera operates in the second operating mode.

3. The mobile device of claim 1, further comprising: a case configured to accommodate the housing, wherein the external antenna and the antenna adjuster are disposed in the case.

4. The mobile device of claim 1, wherein the external antenna is configured as a passive antenna.

5. The mobile device of claim 4,
wherein the antenna adjuster is configured to space the external antenna by a certain distance from the one surface of the housing and position the external antenna in one of a first position or a second position, and
wherein the first position is a position where the external antenna is not electromagnetically coupled with the internal antenna, and the second position is a position where the external antenna is electromagnetically coupled with the internal antenna.

6. The mobile device of claim 5, further comprising: an antenna position detection part disposed in the housing and configured to detect the position of the external antenna, wherein the camera is configured to recognize the position of the external antenna using a signal transmitted from the antenna position detection part.

7. The mobile device of claim 6, wherein the antenna position detection part comprises a magnetometer disposed in the housing, and the magnetometer is configured to detect a permanent magnet disposed in the external antenna.

8. The mobile device of claim 1, wherein the external antenna is configured as an active antenna, and comprises a fixing part that spaces the external antenna from the one surface of the housing by a certain distance and fixes the external antenna to the one surface of the housing.

9. The mobile device of claim 8, wherein the antenna adjuster comprises: a power supply electrically connected to the external antenna, and a power switch between the external antenna and the power supply and configured to allow the power supply to selectively supply power to the external antenna, wherein when the power switch is turned on and power is supplied from the power supply to the external antenna, the external antenna is electromagnetically coupled with the internal antenna so that the electromagnetic waves radiated from the internal antenna form the second antenna radiation pattern, and wherein when the power switch is turned off and power is not supplied to the external antenna, the external antenna is not electromagnetically coupled with the internal antenna so that the electromagnetic waves radiated from the internal antenna form the first antenna radiation pattern.

10. The mobile device of claim 9, wherein the external antenna comprises: four transmission lines arranged in a rectangular shape; and a plurality of switches disposed between the four transmission lines and configured to selectively divide the four transmission lines into two or four parts.

11. The mobile device of claim 1, further comprising: a distance measurement part configured to measure a distance to a subject captured by the camera using electromagnetic waves radiated from the internal antenna.

12. The mobile device of claim 1, wherein the external antenna and the antenna adjuster are detachably disposed on a rear surface of the housing.

13. The mobile device of claim 1, wherein a distance G between the housing and the external antenna is 1/10 to 1/4 of a wavelength of an electromagnetic wave radiated from the internal antenna.

14. A method of measuring a distance to a subject by a mobile device having an internal antenna, an external antenna, and a camera, the method comprising: identifying whether the external antenna is activated; radiating electromagnetic waves through the internal antenna when the external antenna is activated; receiving the electromagnetic waves reflected from the subject; and calculating the distance to the subject.

15. The method of claim 14, wherein when the external antenna is activated, the internal antenna is electromagnetically coupled with the external antenna, thereby changing a first antenna radiation pattern to a second antenna radiation pattern.

16. The method of claim 14, wherein the camera is configured to operate in a first operating mode and a second operating mode, and wherein when the internal antenna is not electromagnetically coupled with the external antenna, the camera operates in the first operating mode, and when the internal antenna is electromagnetically coupled with the external antenna, the camera operates in the second operating mode.

17. The method of claim 14, further comprising: an antenna adjuster on an outside of a housing and configured to selectively electromagnetically couple the external antenna with the internal antenna, wherein the antenna adjuster is configured to space the external antenna by a certain distance from one surface of the housing and position the external antenna in one of a first position or a second position, and wherein the first position is a position where the external antenna is not electromagnetically coupled with the internal antenna, and the second position is a position where the external antenna is electromagnetically coupled with the internal antenna.

18. The method of claim 17, wherein the external antenna and the antenna adjuster are detachably disposed on a rear surface of the housing.

19. One or more non-transitory computer-readable storage media storing one or more computer programs including computer-executable instructions that, when executed by one or more processors of mobile device having an internal antenna, an external antenna, and a camera individually or collectively, cause the mobile device to perform operations, the operations comprising identifying whether the external antenna is activated; radiating electromagnetic waves through the internal antenna when the external antenna is activated; receiving the electromagnetic waves reflected from a subject; and calculating a distance to the subject.

20. The one or more non-transitory computer-readable storage media of claim 19, wherein when the external antenna is activated, the internal antenna is electromagnetically coupled with the external antenna, thereby changing a first antenna radiation pattern to a second antenna radiation pattern.
